(19) United States
(12) Patent Application Publication
(10) Pub. No.: US 2026/0112018 A1
(43) Pub. Date: Apr. 23, 2026

(54) METHODS AND SYSTEMS FOR MANAGING GLASS PANEL CONDITIONING

(71) Applicant: J.B. Poindexter & Company, Houston, TX (US)

(72) Inventors: J. Erik Hellstrom, Houston, TX (US); Adam Klauer, Houston, TX (US)

(21) Appl. No.: 19/366,099

(22) Filed: Oct. 22, 2025

Related U.S. Application Data
(60) Provisional application No. 63/710,980, filed on Oct. 23, 2024.

(51) Int. Cl. G06T 7/00; B60S 1/02

(52) U.S. Cl. CPC G06T 7/0004; B60S 1/026; G06T 2207/20084; G06T 2207/30248

(57) ABSTRACT

Methods and systems are described that are configured for managing an environmental system of a vehicle in order to defrost and/or defog a glass panel of the vehicle. A computing device may control one or more devices of the environmental system based on receiving image data associated with the glass panel and environmental data associated with an interior of the vehicle. The computing device may receive the image data from one or more image capture devices and the environmental data from one or more sensor devices. The computing device may determine an indication of one or more environmental conditions associated with the glass panel based on applying one or more neural networks to the image data. The computing device may control the one or more devices to defog and/or defrost the glass panel based on the indication of the one or more environmental conditions and the environmental data.

### CROSS-REFERENCE TO RELATED APPLICATION

This application claims priority to and the benefit of the filing date of U.S. Provisional Patent Application No. 63/710,980, filed Oct. 23, 2024, the entirety of which is hereby incorporated by reference herein.

### BACKGROUND

Conventional windshields used in vehicles, such as automobiles, airplanes, boats, and other transportation vehicles, are generally composed of glass sheets that include heating networks consisting of strips of resistance, or wires, that enable defrosting and/or defogging of the windshield. In addition, vehicles include an HVAC system configured to defrost and/or defog the windshield. These conventional methods for managing windshield conditions rely on sensing localized environmental parameters from sensors located within an interior cabin of the vehicle. Such sensors typically measure temperature and humidity of the interior cabin environment at discrete points. The control systems then activate heating elements or HVAC components based on these localized measurements and predetermined thresholds or timing sequences.

However, these conventional methods of defrosting and/or defogging the windshield can significantly impact the energy efficiency of the vehicle. This is especially important in electric vehicles that rely on battery packs for powering the vehicle. The reliance on localized point measurements may not accurately reflect the actual conditions across the entire windshield surface, as environmental conditions can vary significantly across different areas of the glass panel. Temperature and humidity sensors positioned within the vehicle cabin may not directly correlate to the specific conditions affecting visibility through the windshield, particularly regarding the presence or absence of fog or frost formation on the glass surface.

Furthermore, conventional systems typically operate according to fixed control algorithms that do not adapt to real-time visual conditions of the windshield. These systems may continue to operate heating elements or HVAC components even when the windshield surface has already achieved adequate clarity, or conversely, may not provide adequate conditioning when localized sensor readings do not accurately reflect the actual state of the windshield surface. These systems often operate at predetermined power levels for fixed durations without regard to the actual conditioning requirements of the windshield surface. This approach can result in excessive energy consumption, which becomes particularly problematic in electric vehicles where battery power directly affects vehicle range and operational efficiency.

Additionally, conventional systems lack the capability to directly assess the visual clarity of the windshield surface. The absence of direct visual feedback regarding the actual state of fog or frost formation on the windshield surface limits the precision and efficiency of conventional conditioning control approaches.

### SUMMARY

It is to be understood that both the following general description and the following detailed description are exemplary and explanatory only and are not restrictive.

Methods, systems, and apparatuses for managing an environmental system of a vehicle for defrosting and/or defogging a glass panel of the vehicle are described. A computing device may control one or more devices (e.g., one or more blower devices, one or more heating devices, one or more air conditioning devices, one or more wiper devices, a wire configured to heat the glass panel, etc.) of the environmental system of the vehicle (e.g., car, truck, automobile, SUV, electric vehicle, delivery vehicle, cargo vehicle, airplane, boat, etc.) to defog or defrost a glass panel (e.g., a windshield, window, glass pane, etc.) of the vehicle. The computing device may receive image data associated with the glass panel from one or more image capture devices and environmental data associated with an interior of the vehicle from one or more sensor devices. The computing device may determine an indication of one or more environmental conditions (e.g., fog build-up on the glass panel, frost build-up on the glass panel, or an absence of fog and frost build-up on the glass panel) associated with the glass panel based on applying one or more neural networks to the image data. The computing device may then control the one or more devices to defog and/or defrost the glass panel based on the indication of the one or more environmental conditions and the environmental data.

In an embodiment, disclosed are methods comprising receiving, by a computing device, via one or more image capture devices, image data associated with a glass panel of a vehicle, receiving, via one or more sensor devices, environmental data associated with an interior of the vehicle, determining, based on an application of one or more neural networks to the image data, an indication of one or more environmental conditions associated with the glass panel, and causing, based on the indication of the one or more environmental conditions associated with the glass panel and based on the environmental data associated with an interior of the vehicle, one or more devices of the vehicle to activate.

In an embodiment, disclosed is are systems comprising one or more image capture devices configured to output image data associated with a glass panel of a vehicle, one or more sensor devices configured to output environmental data associated with an interior of the vehicle, an environmental system of the vehicle comprising one or more devices of the vehicle, a computing device in communication with the one or more image capture devices, the one or more sensor devices, and the environmental system, wherein the computing device is configured to receive the image data associated with the glass panel and the environmental data associated with the interior of the vehicle, determine, based on application of one or more neural networks to the image data, an indication of one or more environmental conditions associated with the glass panel, and cause, based on the indication of the one or more environmental conditions associated with the glass panel and based on the environmental data associated with the interior of the vehicle, the one or more devices of the environmental system to activate.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

To easily identify the discussion of any particular element or act, the most significant digit or digits in a reference number refer to the figure number in which that element is first introduced.

FIG. 1 shows an example system;

FIG. 2 shows an example process for controlling an environmental system;

FIG. 3 shows an example convolutional neural network;

FIG. 4 shows an example structure of convolutional neural network;

FIG. 5 shows an example convolutional neural network training process;

FIG. 6A shows an example system environment;

FIG. 6B shows an example system environment; and

FIG. 7 shows a flowchart of an example method.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes—from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Hereinafter, various embodiments of the present disclosure will be described with reference to the accompanying drawings. As used herein, the term “user” may indicate a person who uses an electronic device.

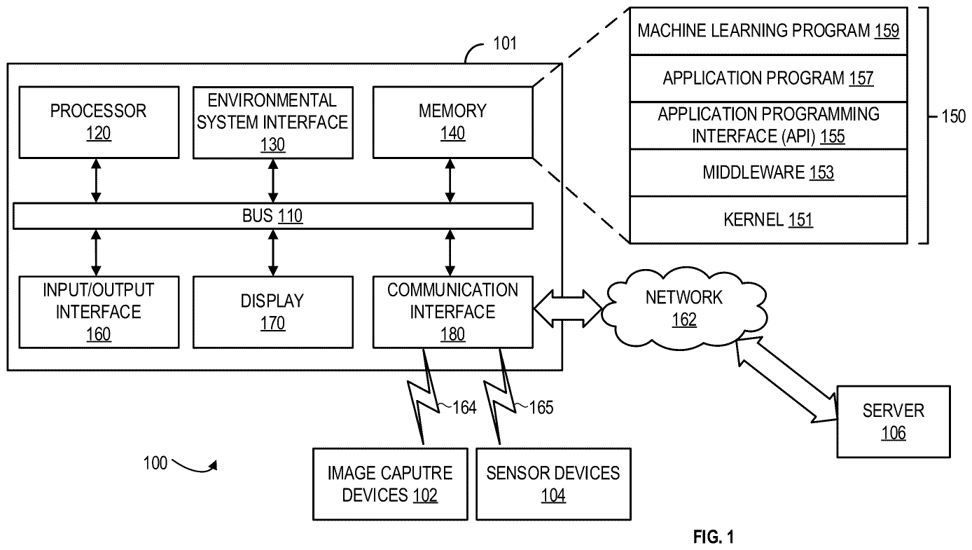

FIG. 1 shows an example system 100 including a computing device 101 configured for managing an environmental system of a vehicle (e.g., car, truck, automobile, SUV, electric vehicle, delivery vehicle, cargo vehicle, airplane, boat, etc.) in order to defrost and/or defog a glass panel (e.g., a windshield, window, a glass pane, etc.) of the vehicle according to various embodiments. The computing device 101 may receive image data associated with the glass panel of the vehicle from one or more image capture devices and environmental data associated with an interior of the vehicle from one or more sensor devices. The computing device 101 may determine an indication of one or more environmental conditions (e.g., fog build-up on the glass panel, frost build-up on the glass panel, or an absence of fog and frost build-up on the glass panel) associated with the glass panel based on applying one or more neural networks to the image data and the environmental data. The computing device 101 may control one or more devices (e.g., one or more blower devices, one or more heating devices, one or more air conditioning devices, one or more wiper devices, a wire configured to heat the glass panel, etc.) of the environmental system to defog and/or defrost the glass panel based on the indication of the one or more environmental conditions and the environmental data. The computing device 101 may be included in the vehicle. The computing device 101 may include a bus 110, a processor 120, an environmental system interface 130, a memory 140, an input/output interface 160, a display 170, and a communication interface 180. In an example, the computing device 101 may omit at least one of the aforementioned constitutional elements or may additionally include other constitutional elements.

The bus 110 may include a circuit for connecting the processor 120, the environmental system interface 130, the memory 140, the input/output interface 160, the display 170, and the communication interface 180 to each other and for delivering communication (e.g., a control message and/or data) between the processor 120, the environmental system interface 130, the memory 140, the input/output interface 160, the display 170, and the communication interface 180.

The processor 120 may include one or more of a Central Processing Unit (CPU), an Application Processor (AP), and a Communication Processor (CP). The processor 120 may control, for example, at least one of the environmental system interface 130, the memory 140, the input/output interface 160, the display 170, and the communication interface 180 and/or may execute an arithmetic operation or data processing for communication. The processing (or controlling) operation of the processor 120 according to various embodiments is described in detail with reference to the following drawings.

The environmental system interface 130 may be configured as an interface for controlling one or more devices of an environmental system of the vehicle (e.g., car, truck, automobile, SUV, electric vehicle, delivery vehicle, cargo vehicle, airplane, boat, etc.). The one or more devices may comprise one or more of one or more blower devices, one or more heating devices, one or more air conditioning devices, one or more wiper devices, or a heating wire configured to heat a glass panel (e.g., a windshield, window, glass pane, etc.) of the vehicle. In an example, the glass panel may comprise integrated heating (e.g., the heating wire). The heating wire may comprise a transparent, semi-conductive metal oxide coating that is applied to the glass panel, wherein electricity is passed through the coating from concealed bus bars at the top and bottom of the glass panel. For example, power may be applied to the bus bars to apply power to the heating wire. As an example, fog and/or frost/mist may accumulate on the glass panel. The one of more devices of the environmental system may be controlled, or activated, to defog and/or defrost the glass panel.

The memory 140 may include a volatile and/or non-volatile memory. The memory 140 may store, for example, a command or data related to at least one different constitutional element of the computing device 101. In an example, the memory 140 may store a software and/or a program 150. The program 150 may include, for example, a kernel 151, a middleware 153, an Application Programming Interface (API) 155, an application program (or an “application”) 157, and/or a machine learning program 159, or the like, configured for controlling one or more functions of the computing device 101 and/or an external device (e.g., one or more sensor devices 102). At least one part of the kernel 151, middleware 153, or API 155 may be referred to as an Operating System (OS). The memory 140 may include a computer-readable recording medium having a program recorded therein to perform the method according to various embodiments by the processor 120.

The kernel 151 may control or manage, for example, system resources (e.g., the bus 110, the processor 120, the memory 140, etc.) used to execute an operation or function implemented in other programs (e.g., the middleware 153, the API 155, the application program 157, or the machine learning program 159). Further, the kernel 151 may provide an interface capable of controlling or managing the system resources by accessing individual constitutional elements of the computing device 101 in the middleware 153, the API 155, the application program 157, or the machine learning program 159.

The middleware 153 may perform, for example, a mediation role so that the API 155, the application program 157, or machine learning program 159 can communicate with the kernel 151 to exchange data.

Further, the middleware 153 may handle one or more task requests received from the application program 157 and/or the machine learning program 159 according to a priority. For example, the middleware 153 may assign a priority of using the system resources (e.g., the bus 110, the processor 120, or the memory 130) of the computing device 101 to at least one of the application programs 157. For example, the middleware 153 may process the one or more task requests according to the priority assigned to at least one of the application programs, and thus, may perform scheduling or load balancing on the one or more task requests.

The API 155 may include at least one interface or function (e.g., instruction), for example, for file control, window control, video processing, or character control, as an interface capable of controlling a function provided by the application 157 and/or the machine learning program 159 in the kernel 151 or the middleware 153.

The application program 157 may include logic (e.g., hardware, software, firmware, etc.) that may be implemented to control, via the environmental interface 130, the environmental system (e.g., the one or more devices) of the vehicle to defog and/or defrost the glass panel of the vehicle. For example, the computing device 101 may receive image data from one or more image capture devices 102 and environmental data from one or more sensor devices 104. The image capture devices 102 may comprise camera devices that are positioned within an interior of the vehicle to capture images of one or more portions of the glass panel. The sensor devices 104 may comprise one or more temperature sensors, humidity/moisture sensors, and/or the heating wire. The sensor devices 104 may be configured to measure/determine a temperature of the interior of the vehicle (e.g., via the temperature sensors), humidity/moisture of the interior of the vehicle (e.g., via the humidity/moisture sensors), and/or a temperature associated with the glass panel (e.g., via the heating wire). The application program 157 may access/retrieve one or more neural networks (e.g., the machine learning program 159) in order to process the image data. For example, the application program 157 may apply the one or more neural networks to the image data in order to determine an indication of one or more environmental conditions associated with the glass panel (e.g., detect fog build-up on the glass panel, frost build-up on the glass panel, or an absence of fog and frost build-up on the glass panel). For example, based on applying the one or more neural networks to the image data, the computing device 101 may determine whether frost and/or fog is on the glass panel. For example, the computing device 101 may determine a probability of fog and/or frost based on applying the one or more neural networks to the image data. As an example, the probability may be associated with a continuous value between 0 and 1, wherein the continuous value comprises an indicator of the visibility through the glass panel. For example, a low probability may indicate high visibility that is not obstructed by fog and/or frost on the glass panel and a high probability may indicate low visibility that is obstructed due to fog and/or frost on the glass panel. The application program 157 may cause the computing device 101 to control the one or more devices of the environmental system based on whether frost and/or fog is detected on the glass panel and based on the environmental data. For example, the application program 157 may cause the computing device 101 to activate the one or more devices to defrost and/or defog the glass panel based on the environmental data. For example, the application program 157 may cause the computing device 101 to adjust settings of one or more of the devices based on the environmental data. For example, the application program 157 may cause the computing device 101 to adjust an amount of air circulated based on the blower devices, an air temperature being output based on the air conditioning and/or heating devices, a wiper speed, and/or an amount of heat applied to the glass panel via the heating wire based on the environmental data in order to defrost and/or defog the glass panel. In an example, the computing device 101 may receive user input comprising a selection of a control mode (e.g., a defrost mode, a defog mode, etc.) associated with the glass panel. The application program 157 may cause the computing device 101 to activate the one or more devices to defrost and/or defog the glass panel based on whether frost and/or fog is detected on the glass panel and based on receiving the user input of the control mode. In an example, the computing device 101 may determine a heating power to output to the environmental system of the vehicle based on whether frost and/or fog is detected on the glass panel. The one or more devices may be activated based on the heating power. For example, each device may be prioritized based on an energy efficiency associated with each device. As one example, in a defrost mode, the computing device 101 may determine a desired heating power with a desired set-point, wherein the set-point may comprise a desired visibility threshold (e.g., a value P comprising a low value of the probability of frost and/or fog). For example, if a maximum power is determined, one or more of the devices may be activated. For example, a heating device (e.g., convective heating device) may be prioritized to be activated first. The additional devices (e.g., blower devices, air conditioning devices, wiper devices, heating wire, etc.) may be activated based on a priority associated with each device. In addition, wipers (e.g., available on a front windshield of the vehicle) may be prioritized to help clear the glass panel. As another example, in defog mode, the computing device 101 may determine a heating power for mitigating fog forming an on interior surface of the glass panel. In addition, the wipers may be activated to mitigate any condensation on an outside surface of the glass panel.

The machine learning program 159 may include logic (e.g., hardware, software, firmware, etc.) that may be implemented to process/analyze the image data to determine an indication of one or more environmental conditions associated with the glass panel. For example, the machine learning program 159 may be implemented to determine whether there is frost and/or fog on the glass panel. The machine learning program 159 may comprise one or more neural networks, including one or more convolutional neural networks. The image data may be initially analyzed by one or more convolutional neural networks to extract image features associated with fog and/or frost. For example, a first convolutional neural network may be applied to the image data to determine (e.g., extract) one or more fog features and/or a second convolutional neural network may be applied to the image data to determine (e.g. extract) one or more frost features. The features extracted from the image data may be analyzed by one or more neural networks to determine a probability of fog and/or frost on the glass panel based on the captured images. As an example, the probability of fog and/or frost on the glass panel may comprise an indicator (e.g., a value between 0 and 1) of the visibility through the glass panel. For example, a low probability may indicate high visibility that is not obstructed by fog and/or frost on the glass panel and high probability may indicate low visibility that is obstructed due to fog and/or frost on the glass panel. For example, a first neural network may be applied to the one or more fog features to determine a probability of fog on the glass panel and/or a second neural network may be applied to the one or more frost features to determine a probability of frost on the glass panel. In an example, the first convolutional neural network and the first neural network may be jointly trained based on one or more input training datasets comprising a plurality of images associated with a plurality of glass panel conditions and one or more output training datasets comprising a plurality of labeled images corresponding to a probability of fog build-up on a glass panel. In addition, the second convolutional neural network and the second neural network may be jointly trained based on one or more input training datasets comprising a plurality of images associated with a plurality of glass panel conditions and one or more output training datasets comprising a plurality of labeled images corresponding to a probability of frost build-up on a glass panel.

The input/output interface 160 may be configured as an interface for delivering an instruction or data input from a user or a different external device(s) to the processor 120, the environmental system interface 130, the memory 140, the input/output interface 160, the display 170, and the communication interface 180. For example, input/output interface 160 may receive user input of a selection of a control mode (e.g., a defrost mode, a defog mode, etc.) associated with the glass panel. Further, the input/output interface 160 may output an instruction or data received from the processor 120, the environmental system interface 130, the memory 140, the input/output interface 160, the display 170, and/or the communication interface 180 to a different external device.

The display 170 may include various types of displays, such as, for example, a Liquid Crystal Display (LCD) display, a Light Emitting Diode (LED) display, an Organic Light-Emitting Diode (OLED) display, a MicroElectroMechanical Systems (MEMS) display, or an electronic paper display. The display 170 may display, for example, a variety of contents (e.g., text, image, video, icon, symbol, etc.) to the user. The display 170 may include a touch screen. For example, the display 170 may receive a touch, gesture, proximity, or hovering input by using a stylus pen or a part of a user's body.

The communication interface 180 may establish, for example, communication between the computing device 101 and an external device (e.g., the one or more image capture devices 102, the one or more sensor devices 104, or a server 106). For example, the communication interface 180 may communicate with the external device (e.g., the server 106) by being connected to a network 162 via wireless communication or wired communication. For example, as a cellular communication protocol, the wireless communication may use at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. In an example, the network 162 may include, for example, at least one of a telecommunications network, a computer network (e.g., LAN or WAN), the internet, and a telephone network.

In addition, the communication interface 180 may communicate with the external device (e.g., the one or more image capture devices 102 and/or the one or more sensor devices 104) via a communication connection 164 such as a wireless communication and/or wired communication. The wireless communication may include, for example, a near-distance communication. The near-distance communications may include, for example, at least one of Wireless Fidelity (WiFi), Bluetooth, Near Field Communication (NFC), Global Navigation Satellite System (GNSS), and the like. According to a usage region or a bandwidth or the like, the GNSS may include, for example, at least one of Global Positioning System (GPS), Global Navigation Satellite System (Glonass), Beidou Navigation Satellite System (hereinafter, “Beidou”), Galileo, the European global satellite-based navigation system, and the like. Hereinafter, the “GPS” and the “GNSS” may be used interchangeably in the present document. The wired communication may include, for example, at least one of Controller Area Network (CAN), Local Interconnect Network (LIN), Single Edge Nibble Transmission (SENT), FlexRay, Universal Serial Bus (USB), High Definition Multimedia Interface (HDMI), Recommended Standard-232 (RS-232), power-line communication, Plain Old Telephone Service (POTS), and the like.

The server 106 may comprise a group of one or more servers. In an example, all or some of the operations executed by the computing device 101 may be executed in a different one or a plurality of electronic devices (e.g., the one or more image capture devices 102, the one or more sensor devices 104, or the server 106). In an example, if the computing device 101 needs to perform a certain function or service either automatically or based on a request, the computing device 101 may request at least some parts of functions related thereto alternatively or additionally to a different electronic device (e.g., the one or more image capture devices 102, the one or more sensor devices 104, or the server 106) instead of executing the function or the service autonomously. The different electronic devices (e.g., the one or more image capture devices 102, the one or more sensor devices 104, or the server 106) may execute the requested function or additional function, and may deliver a result thereof to the computing device 101. The computing device 101 may provide the requested function or service either directly or by additionally processing the received result. For example, a cloud computing, distributed computing, or client-server computing technique may be used. In an example, the computing device 101 may receive the image data from the one or more image capture devices 102 and the environmental data from the one or more sensor devices 104 and output the image data and the environmental data to the server 106. The server 106 may be configured to process the image data and the environmental data to determine an indication of the one or more environmental conditions associated with the glass panel of the vehicle and output the indication of the one or more environmental conditions to the computing device 101.

The implementation of a vision-based approach for defrosting and/or defogging a glass panel (e.g., windshield) of a vehicle represents a technical improvement over conventional glass panel conditioning systems by addressing the technical problem of inaccurate environmental condition detection and inefficient energy consumption. Conventional systems typically rely on localized point measurements from discrete sensors positioned within the vehicle cabin, which may not accurately reflect the actual conditions across the entire glass panel surface. In contrast, the implementation of a vision-based approach that directly analyzes the visual state of the glass panel through neural network processing of image data captured by strategically positioned cameras provides a more accurate detection of fog and frost conditions compared to indirect measurements from cabin-based sensors. Additionally, the system may optimize energy consumption by dynamically adjusting the activation and power levels of conditioning devices based on real-time visual feedback and environmental data, rather than operating according to fixed control algorithms. The neural network-based analysis may enable the system to distinguish between different types of visibility obstructions and apply appropriate conditioning responses, potentially reducing unnecessary energy consumption while maintaining optimal glass panel clarity. Furthermore, one or more devices may be based on energy efficiency characteristics, allowing the system to achieve desired conditioning results while minimizing overall power consumption, which may be particularly beneficial in electric vehicles where energy efficiency directly impacts operational range.

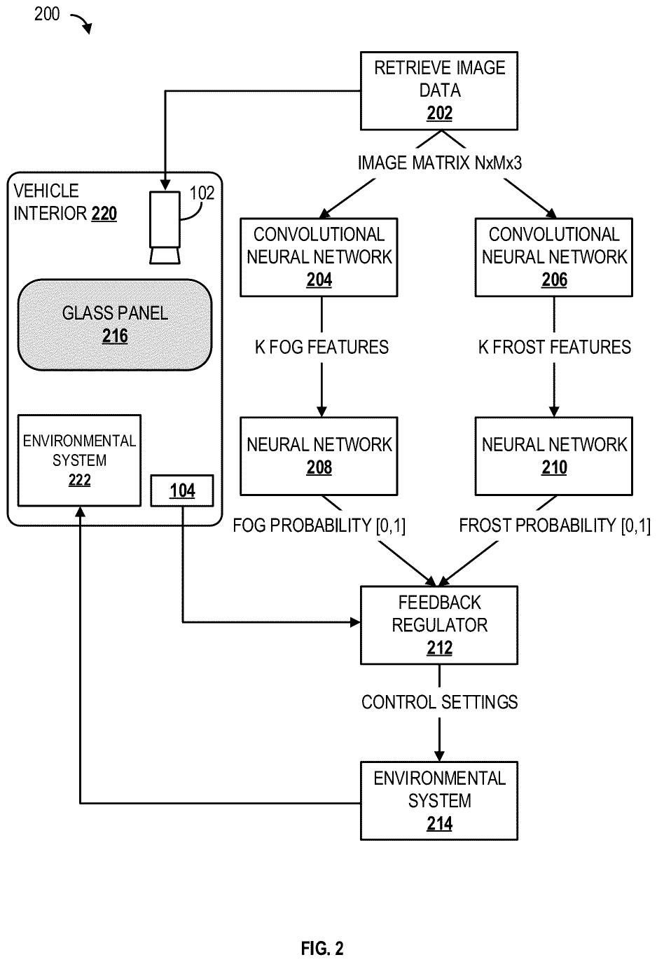

FIG. 2 shows an example, process 200 for controlling an environmental system 222 of a vehicle (e.g., car, truck, automobile, SUV, electric vehicle, delivery vehicle, cargo vehicle, airplane, boat, etc.) in order to defrost and/or defog a glass panel 216 (e.g., a windshield, window, glass pane, etc.) of the vehicle. The method 200 may be implemented by a computing device (e.g., computing device 101, etc.). At 202, image data associated with the glass panel 216 may be received from one or more image capture devices 102. The one or more image capture devices 102 may be placed at one or more locations in an interior 220 of the vehicle. As an example, the image data may be continuously received from the image capture devices 102. The image data may comprise digital images represented as N×M×3 matrices wherein N and M comprise rows (height) and columns (width) with 3 channels of color information such as RGB (red-green-blue) values between 0 and 255.

At 204, the image data may be provided to a first convolutional neural network, wherein the first convolutional neural network may analyze the image data to extract one or more image features (e.g., one or more fog features) for the purpose of fog detection. The first convolutional neural network may comprise multiple convolutional layers, wherein each layer may comprise a decreasing number of rows and columns and an increasing number of channels A last layer of the first convolutional neural network may comprise K1 fog features (e.g., outputs) in total.

At 206, the image data may be provided to a second convolutional neural network, wherein the second convolutional neural network may analyze the image data to extract one or more image features (e.g., one or more frost features) for the purpose of frost detection. The second convolutional neural network may comprise multiple convolutional layers, wherein each layer may comprise a decreasing number of rows and columns and an increasing number of channels. A last layer of the first convolutional neural network may comprise K2 frost features (e.g., outputs) in total.

At 208, the K1 features (e.g., fog features) may be provided to a first neural network classifier, wherein the first neural network may analyze the K1 features to determine a probability of fog on the glass panel 216. For example, the first neural network classifier may comprise one or more dense layers and a sigmoid output activation layer configured to output a value between 0 and 1, which represents the probability of fog on the glass panel 216. The first convolutional neural network and the first neural network may be jointly trained based on one or more input training datasets comprising a plurality of images associated with a plurality of glass panel 216 conditions and one or more output training datasets comprising a plurality of labeled images corresponding to a probability of fog build-up on a glass panel 216.

At 210, the K2 features (e.g., frost features) may be provided to a second neural network classifier, wherein the second neural network may analyze the K2 features to determine a probability of frost on the glass panel 216. For example, the second neural network classifier may comprise one or more dense layers and a sigmoid output activation layer configured to output a value between 0 and 1, which represents the probability of frost on the glass panel 216. The second convolutional neural network and the second neural network may be jointly trained based on one or more input training datasets comprising a plurality of images associated with a plurality of glass panel 216 conditions and one or more output training datasets comprising a plurality of labeled images corresponding to a probability of frost build-up on a glass panel 216.

At 212, a feedback regulator may determine desired settings for the environmental system 222 of the vehicle based on the probabilities of fog and/or frost on the glass panel 216 and based on environmental data received from the one or more sensors 104. The environmental system 222 may comprise one or more of one or more blower devices, one or more heating devices, one or more air conditioning devices, one or more wiper devices, or a wire configured to heat the glass panel 216. The environmental data may comprise data indicative of one or more characteristics of the interior 222 of the vehicle. The one or more characteristics may comprise one or more of temperature or humidity. As an example, the feedback regulator may be configured to arbitrate between fog and frost mitigation objectives and a selection of a control mode (e.g., defog control mode, defrost control mode, etc.) to determine the desired settings for the environmental system 222. For example, the feedback regulator may determine an amount of air to be circulated based on the blower devices, an air temperature to be output based on the air conditioning and/or heating devices, a wiper speed, and/or an amount of heat to be applied to the glass panel 216 via the heating wire based on the environmental data in order to defrost and/or defog the glass panel 216.

In one example, in a defrost mode, the feedback regulator may determine a desired heating power (e.g., by a proportional-integral-derivative type regulator) with a desired set-point as a low probability. Thus, the heating power may be determined, at an instant denoted by subscript n, by:

$$L ( {e}_{n} + \frac{{T}_{S}}{{T}_{I}} {\sum }_{k = 0}^{n} {e}_{k} + {T}_{D} \frac{{e}_{n} - {e}_{n - 1}}{{T}_{S}} )$$

wherein (L, Tₛ, Tₗ, T_{d}) comprise a gain, a sample time, an integrator tuning parameter, and a derivative parameter, respectively. If the desired heating power reaches a maximum value for the glass panel heating, additional devices, such as a convective heating system, may be activated. In an example, the additional devices may be activated according to a prioritization hierarchy based on an energy efficient of each device. As an example, glass panel heating is typically more energy-efficient compared to convective heating and as such glass panel heating may be prioritized over convective heating. As another example, the wipers (e.g., located on a front windshield) may be prioritized to help clear the glass panel 216.

In another example, in defog mode, the desired heating power may be determined analogously to mitigate fog forming on an interior 222 surface of the glass panel 216. In additional, the wipers may be prioritized to mitigate any condensation on an exterior surface of the glass panel 216.

At 214, the feedback regulator output may be output to the environmental system 222. As an example, environmental system 222 may adjust an amount of air circulated based on the blower devices, an air temperature being output based on the air conditioning and/or heating devices, a wiper speed, and/or an amount of heat applied to the glass panel via the heating wire based on the probabilities of fog and frost on the glass panel 216 and based on the environmental data in order to defrost and/or defog the glass panel 216. In one example, in a system with heated glass (e.g., e-glass) and convective heating in a defrost control mode, the desired heating power may be allocated to the heated glass and if the maximum power used by the heated glass is less than the desired heating power, the convective heating may be enabled for the remaining desired heating power.

The method 200 represents a technical improvement over conventional glass panel conditioning approaches by addressing the technical problem of inadequate real-time condition assessment and suboptimal resource allocation in vehicle environmental systems. Conventional methods typically operate based on predetermined schedules or basic threshold-based triggers that may not accurately reflect the actual visual clarity requirements of the glass panel surface. In contrast, the method 200 may implement a dual-pathway neural network architecture that separately analyzes fog and frost conditions through specialized convolutional neural networks, enabling more precise identification of specific visibility obstructions. The method 200 may further enhance system performance by integrating probability-based assessments from the neural network classifiers with real-time environmental sensor data in the feedback regulator, allowing for dynamic adjustment of conditioning device parameters based on actual glass panel conditions rather than indirect cabin measurements. Additionally, the method 200 may optimize energy utilization through the implementation of device prioritization hierarchies that consider energy efficiency characteristics, potentially reducing overall power consumption while maintaining desired glass panel clarity levels. The proportional-integral-derivative control approach implemented in the feedback regulator may enable responsive and stable control of heating power allocation, allowing the system to achieve target visibility conditions more efficiently than fixed-output conventional systems.

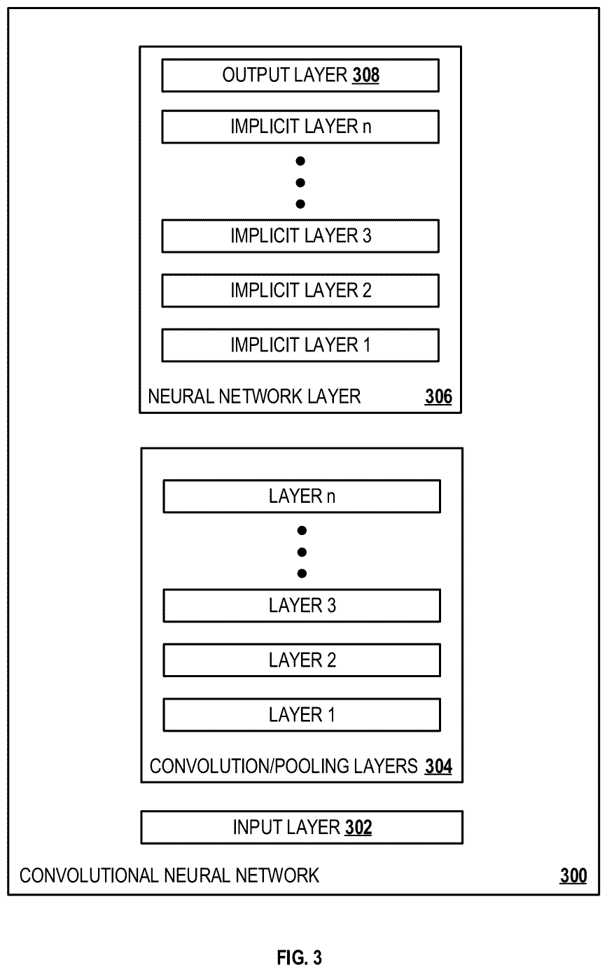

FIG. 3 shows an example convolutional neural network 300. For example, a convolutional neural network 300 may include an input layer 302, convolution layers/pooling layers 304, and a neural network layer 306. The convolution layers/pooling layers 304 may include 1 to n number of layers. In one example, a first layer 1 may comprise a convolution layer while a next layer 2 may comprise a pooling layer which may be repeated for n layers. In another example, a first layer 1 and a next layer 2 may comprise convolution layers while a third layer 3 may comprise a pooling layer which may be repeated for n layers. As such, an output of a convolution layer may be used as an input of a following pooling layer or may be used as an input of another convolution layer to continue to perform convolution.

The first layer 1 (e.g., convolution layer) may include a plurality of convolution filters. A convolution filter may comprise a weight matrix. For example, during image processing, a convolution filter extracts specific information from an input image matrix. The weight matrix may process an image by processing one pixel after another pixel or two pixels after another two pixels in an input image along a horizontal direction in order to complete a task of extracting a specific feature (e.g., fog, frost, etc.) from the image. A size of the weight matrix may be related to a size of the image. A depth dimension of the weight matrix may be the same as a depth dimension of the input image. During a convolution operation, the weight matrix may extend to an entire depth of the input image. The depth dimension may also comprise channel dimension, wherein the channel dimension may correspond to a quantity of channels (e.g., 3 channels). Thus, one convolutional output with a single depth dimension may be generated after convolution is performed by using a single weight matrix. In an example, a plurality of weight matrices with a same size (M rows×N columns) may be applied instead of a single weight matrix. Outputs of the weight matrices may be stacked to form a depth dimension of a convolutional image. In an example, different weight matrices may be used to extract different features of an image (e.g., image of a glass panel). For example, a weight matrix may be used to extract edge information of the image, another weight matrix may be used to extract a specific color of the image, and still another weight matrix may be used to blur unnecessary noise in the image. The plurality of weight matrices may have the same size (M rows×N columns). Feature graphs extracted by using the plurality of weight matrices with the same size may also have a same size. The plurality of extracted feature graphs with the same size may then be combined to form a convolution operation output. As an example, before convolution operations are performed by using convolution layers, secondary convolution filters may be obtained based on primary convolution filters of the convolution layers. A convolution operation may be performed on input image information at each convolution layer by using a primary convolution filter and a secondary convolution filter of the convolution layer.

When the convolutional neural network 300 has a plurality of convolution layers, an initial convolution layer (e.g., first layer 1) may extract a quantity of general features from an input image. The general feature may comprise a low-level feature. As a depth of the convolutional neural network 300 increases, a feature extracted by a subsequent convolution layer (e.g., layer 3) becomes more complex. For example, the feature may comprise a high-level feature. A higher-level feature may be more applicable to a to-be-resolved problem (e.g., determining fog or frost on a glass panel).

Pooling layers may be periodically introduced after convolution layers in order to reduce training parameters associated with the convolutional neural network 300. As an example, in layers 1 to n, as shown in FIG. 3, one convolution layer may be followed by one pooling layer, or a plurality of convolution layers may be followed by one or more pooling layers. During image processing, an objective of a pooling layer is to reduce a space size of an image. The pooling layer may be used to perform an average pooling operation and/or a maximum pooling operation in order to perform sampling on an input image to obtain a smaller-size image. The average pooling operation may be used to perform calculation on pixel values in the image in a specific range in order to generate an average value. The average value may comprise an average pooling result. The maximum pooling operation may be used to take a maximum pixel value in the specific range as a maximum pooling result. In addition, a size of a weight matrix at a convolution layer can be related to an image size, and similarly, an operator at a pooling layer may also be related to an image size. A size of an output image obtained through processing at a pooling layer may be smaller than a size of an input image of the pooling layer. Each pixel in an output image of the pooling layer may represent an average value or a maximum value of a corresponding sub-region of the input image of the pooling layer.

After processing is performed at the convolution layers/pooling layers 304, the convolutional neural network 300 still cannot output required output information (e.g., a determination of fog and/or frost on a glass panel), because as described above, at the convolution layers/pooling layers 304, only a feature is extracted, and parameters resulting from an input image are reduced. However, to generate final output information (e.g., a determination of fog and/or frost on a glass panel), the convolutional neural network 300 needs to generate, by using a neural network layer 306, one output or a group of outputs that comprise a quantity that is equal to a quantity of required classes. Therefore, the neural network layer 306 may include a plurality of implicit layers (e.g., implicit layer 1 to implicit layer n, as shown in FIG. 3) and an output layer 308. Parameters included in the plurality of implicit layers may be obtained by performing pre-training based on training data. For example, the training data may comprise one or more input training datasets comprising a plurality of images associated with a plurality of glass panel conditions and one or more output training datasets comprising a plurality of labeled images corresponding to a probability of fog build-up on a glass panel and a plurality of labeled images corresponding to a probability of frost build-up on a glass panel. For example, the training data may be associated with specific task types such as image recognition, image classification, and super-resolution image reconstruction.

An output layer 308 may be included after the plurality of implicit layers in the neural network layer 306. For example, the output layer 308 may comprise a last layer in the convolutional neural network 300. The output layer 308 has a loss function similar to classification cross entropy. The loss function may be used to calculate a predicted error. Once forward propagation (e.g., a propagation in a direction from 304 to 308) of the entire convolutional neural network 300 is completed, weighted values and offsets of the aforementioned layers start to be updated in backpropagation (e.g., a propagation in a direction from 308 to 304) in order to reduce a loss of the convolutional neural network 300 and an error between an ideal result (e.g., probability of fog/frost on a glass panel) and a result (e.g., fog/frost on a glass panel) output by the convolutional neural network 300 by using the output layer 308.

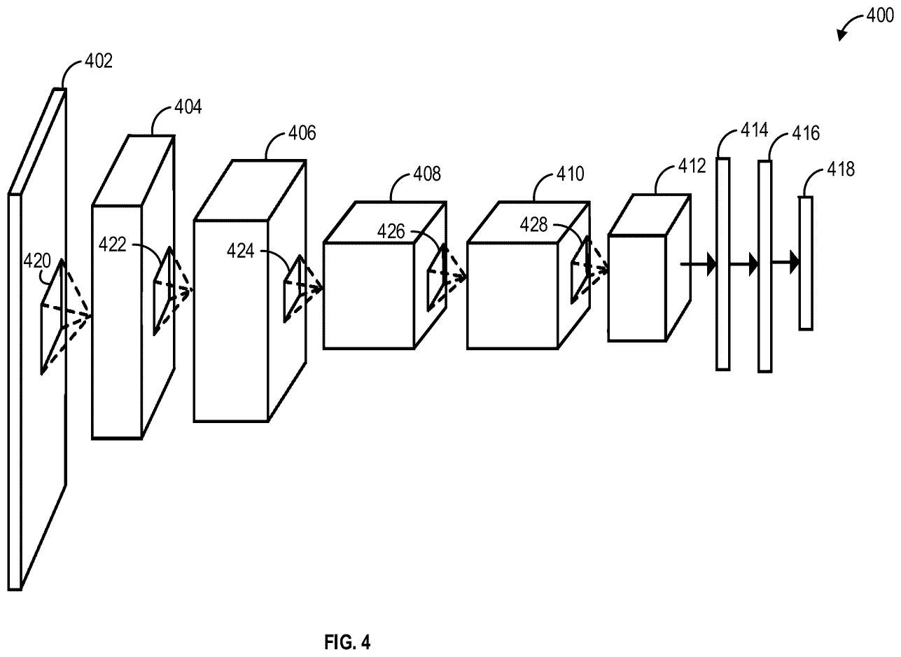

FIG. 4 shows an example structure of a convolutional neural network 400. As an example, the convolutional neural network 400 may include five convolution layers and three fully connected layers. Layers 402 to 410 may comprise input image information of a first convolution layer to a fifth convolution layer sequentially. Layers 404 to 412 may comprise output feature graphs of the first convolution layer to the fifth convolution layer sequentially. The first convolution layer 402 to the fifth convolution layer 410 may comprise sliding windows 420 to 428, respectively (e.g., two-dimensional matrices). The sizes of the sliding windows 420 to 428, respectively, may be smaller than the sizes of the convolution layers 402 to 410. For example, the sizes (e.g., M rows×N columns×Channels) of the layers 402 to 412 may comprise 227×227×3, 55×55×96, 27×27×256, 13×13×384, 13×13×384, 13×13×256, respectively, while the sizes (e.g., M rows×N columns) of the sliding windows of each layer may comprise 11×11, 5×5, 3×3, 3×3, 3×3, respectfully. Layers 414 to 418 may comprise three fully connected layers. In an example, layer 414 may comprise a flatten layer, while layer 418 may comprise an output layer that outputs one or more feature classifications of an input image. For example, the output layer 418 may output one or more fog features or classifications, or one or more frost features, or classifications, based on training the convolutional neural network.

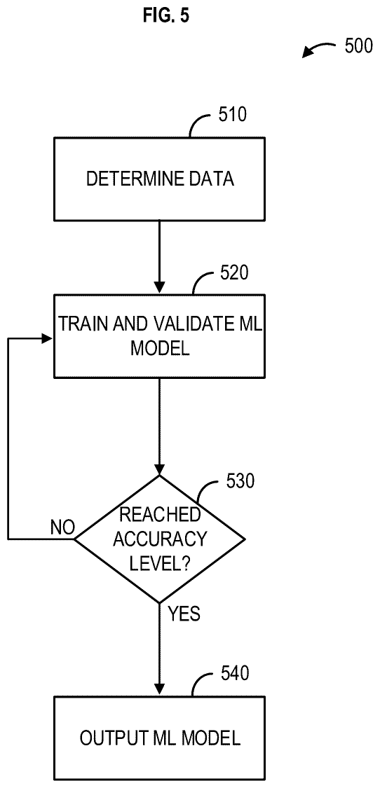

FIG. 5 shows an example convolutional neural network training process 500. The training process 500 may be implemented by a computing device (e.g., computing device 101). At step 510, one or more training data sets may be determined (e.g., access, receive, retrieve, etc.). In one example, one or more input training datasets may comprise a plurality of images associated with a plurality of glass panel conditions and one or more output training datasets may comprise a plurality of labeled images corresponding to a probability of fog build-up on a glass panel for training one or more convolutional neural networks to determine a probability of fog on a glass panel. In another example, one or more input training datasets may comprise a plurality of images associated with a plurality of glass panel conditions and one or more output training datasets may comprise a plurality of labeled images corresponding to a probability of frost build-up on a glass panel.

At step 520, one or more convolutional neural networks may be trained based on the one or more training datasets. The plurality of images of the one or more training datasets may be reformatted into a uniform format and size for input into the convolutional neural networks. The convolutional neural networks may process each image of the datasets to generate output vectors, wherein a highest value of each output vector (e.g., forward propagation) may represent a detected object class (e.g., fog, frost, etc.). A loss function, or value, may be determined based on target values and actual values resulting from the output of the convolutional neural networks. The loss function may comprise a deviation value (e.g., target value minus actual value) that may be fed backward through all of the components of the convolutional neural networks until the deviation value reaches the starting layer of the convolutional neural networks (e.g., backpropagation). As an example, backpropagation allows the convolutional neural networks to determine how much each weight in the convolutional neural networks contributed to the errors and adjust each weight accordingly.

At step 530, the convolutional neural networks may be evaluated to determine whether the predicted values have achieved a desired accuracy level. For example, step 520 may be repeated until the loss value drops below a threshold value. Once the desired accuracy level is achieved, the convolutional neural networks may be output at step 540.

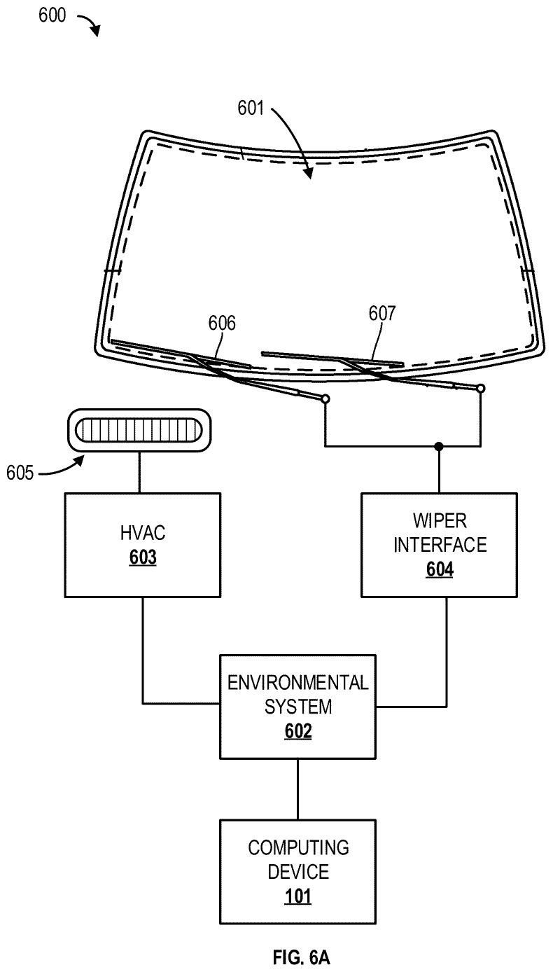

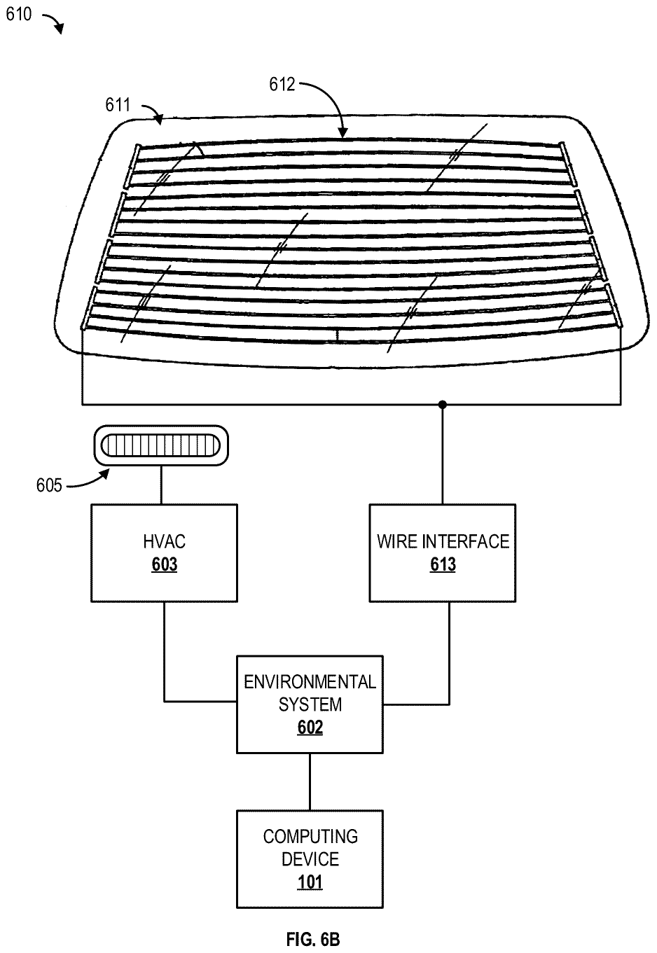

FIGS. 6A-6B show example system environments 600, 610. As an example, a front windshield 601 my only provide windshield wipers 606, 607 for assisting in defogging and/or defrosting the front windshield 601, as shown in FIG. 6A, while a rear windshield 611 may only provide a heating wire 612 for assisting in defogging and/or defrosting the rear windshield 610. As shown in FIG. 6A, a vehicle may include a computing device 101, a windshield 601 (e.g., a glass panel), and an environmental system 602 configured to control an HVAC device 603 for controlling the air flow into the interior of the vehicle and a wiper interface 604 for controlling the windshield wipers 606, 607. Based on image data received from one or more image capture devices (e.g., image capture devices 102) and environmental data received from one or more sensor devices (e.g., sensor devices 104), the computing device 101 may control the environmental system 602 to defog and/or defrost the windshield 601. The environmental data may comprise one or more of temperature or humidity associated with the interior of the vehicle. For example, the computing device 101 may determine whether there is fog and/or frost on the windshield 601 based on the image data. Based on whether there is fog and/or frost on the windshield 601 and based on the temperature and/or humidity detected in the interior of the vehicle, the computing device may control the environmental system 602 to activate one or more devices of the vehicle. For example, the computing device 101 may control the environmental system 602 to adjust an amount of air circulated based on the blower devices via the HVAC 603 and vent 605, an air temperature being output via the HVAC 603 and vent 605, and/or a wiper speed of the wipers 606, 607 via the wiper interface 604 based on the environmental data in order to defrost or defog the glass panel. As shown in FIG. 6B, a vehicle may include a computing device 101, a windshield 611 (e.g., a glass panel), and an environmental system 602 configured to control an HVAC device 603 for controlling the air flow into the interior of the vehicle and a heating wire interface 613 for controlling a heating wire 612 to heat the windshield 611. As an example, the computing device 101 may control the environmental system 602 to adjust an amount of air circulated based on the blower devices via the HVAC 603 and vent 605, an air temperature being output via the HVAC 603 and vent 605, and/or an amount of heat applied to the windshield 611 via the heating wire 612 via the heating wire interface 613.

The implementation of a vision-based approach for defrosting and/or defogging a glass panel (e.g., windshield) of a vehicle represents a technical improvement over conventional windshield conditioning systems by addressing the technical problem of inaccurate environmental condition detection and inefficient energy consumption. Conventional systems typically rely on localized point measurements from discrete sensors positioned within the vehicle cabin, which may not accurately reflect the actual conditions across the entire glass panel surface. In contrast, the implementation of a vision-based approach that directly analyzes the visual state of the glass panel through neural network processing of image data captured by strategically positioned cameras provides a more accurate detection of fog and frost conditions compared to indirect measurements from cabin-based sensors. Additionally, the system may optimize energy consumption by dynamically adjusting the activation and power levels of conditioning devices based on real-time visual feedback and environmental data, rather than operating according to fixed control algorithms. The neural network-based analysis may enable the system to distinguish between different types of visibility obstructions and apply appropriate conditioning responses, potentially reducing unnecessary energy consumption while maintaining optimal glass panel clarity. Furthermore, one or more devices may be based on energy efficiency characteristics, allowing the system to achieve desired conditioning results while minimizing overall power consumption, which may be particularly beneficial in electric vehicles where energy efficiency directly impacts operational range.

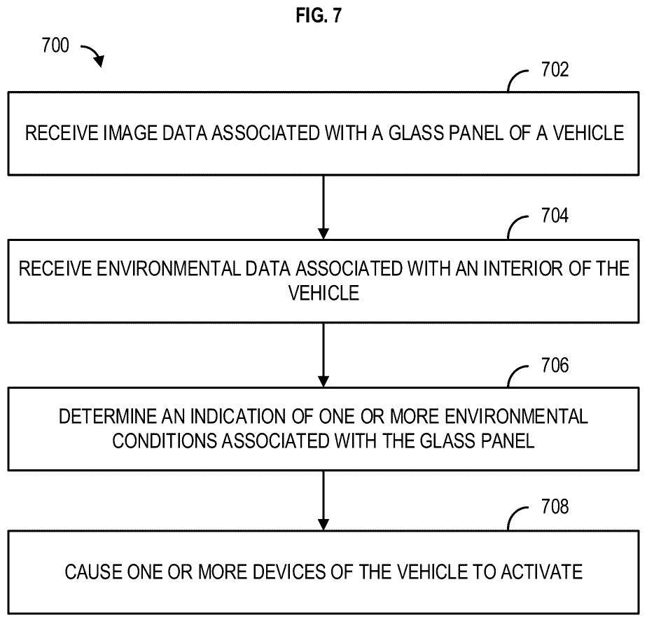

FIG. 7 shows a flowchart of an example method 700. The method 700 may be implemented by a computing device (e.g., computing device 101, etc.). At step 702, image data associated with a glass panel of a vehicle may be received. For example, the image data may be received by a computing device (e.g., computing device 101, etc.) via one or more image capture devices (e.g., image capture devices 102). The image data may comprise one or more images of one or more portions of the glass panel. The glass panel may comprise a wire configured to heat the glass panel.

At step 704, environmental data associated with an interior of the vehicle may be received. For example, the environmental data may be received by the computing device (e.g., computing device 101, etc.) via one or more sensor devices (e.g., sensor devices 104). The environmental data may comprise data indicative of one or more characteristics of the interior of the vehicle. The one or more characteristics may comprise one or more of temperature or humidity.

At step 706, an indication of one or more environmental conditions associated with the glass panel may be determined based on an application of one or more neural networks to the image data. For example, the computing device (e.g., computing device 101, etc.) may determine the indication of the one or more environmental conditions associated with the glass panel based on the application of the one or more neural networks to the image data. The one or more environmental conditions may comprise one or more of fog build-up on the glass panel, frost build-up on the glass panel, or an absence of fog and frost build-up on the glass panel. As an example, one or more image features associated with the image data may be determined based on an application of one or more convolutional neural networks to the image data. The indication of the one or more environmental conditions associated with the glass panel may be determined based on an application of one or more neural networks to the one or more image features. In one example, one or more fog features associated with the image data may be determined based on an application of a first convolutional neural network to the image data. An indication of fog on the glass panel may be determined based on an application of a first neural network to the one or one fog features associated with the image data. In another example, one or more frost features associated with the image data may be determined based on an application of a second convolutional neural network to the image data. An indication of frost on the glass panel may be determined based on an application of a second neural network to the one or more frost features associated with the image data. The first convolutional neural network and the first neural network may be jointly trained based on one or more input training datasets comprising a plurality of images associated with a plurality of glass panel conditions and one or more output training datasets comprising a plurality of labeled images corresponding to a probability of fog build-up on a glass panel. The second convolutional neural network and the second neural network may be jointly trained based on one or more input training datasets comprising a plurality of images associated with a plurality of glass panel conditions and one or more output training datasets comprising a plurality of labeled images corresponding to a probability of frost build-up on a glass panel.

At step 708, one or more devices of the vehicle may be activated based on the indication of the one or more environmental conditions associated with the glass panel and based on the environmental data associated with an interior of the vehicle. For example, the computing device (e.g., computing device 101, etc.) may activate the one or more devices of the vehicle based on the indication of the one or more environmental conditions associated with the glass panel and based on the environmental data associated with the interior of the vehicle. The one or more devices may comprise one or more of one or more blower devices, one or more heating devices, one or more air conditioning devices, one or more wiper devices, or a wire configured to heat the glass panel. In an example, a user input of a selection of a control mode associated with the glass panel may be received. The one or more devices of the vehicle may be activated based on the indication of the one or more environmental conditions and based on the environmental data and based on the selection of the control mode associated with the glass panel. The control mode may comprise a defrost mode or a defog mode. In an example, a heating power may be determined based on the indication of the one or more environmental conditions and based on the environmental data. The one or more devices may be activated based on the heating power. For example, each device of the one or more devices may be activated based on a priority of each device. The priority of each device may be based on an energy efficiency associated with each device.

For purposes of illustration, application programs and other executable program components are illustrated herein as discrete blocks, although it is recognized that such programs and components can reside at various times in different storage components. An implementation of the described methods can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
receiving, by a computing device, via one or more image capture devices, image data associated with a glass panel of a vehicle;
receiving, via one or more sensor devices, environmental data associated with an interior of the vehicle;
determining, based on an application of one or more neural networks to the image data, an indication of one or more environmental conditions associated with the glass panel; and
causing, based on the indication of the one or more environmental conditions associated with the glass panel and based on the environmental data associated with the interior of the vehicle, one or more devices of the vehicle to activate.

2. The method of claim 1, wherein the image data comprises one or more images of one or more portions of the glass panel, wherein the environmental data comprises data indicative of one or more of a temperature or a humidity of the interior of the vehicle.

3. The method of claim 1, wherein the glass panel comprises a wire configured to heat the glass panel, and wherein the one or more devices comprise one or more of one or more blower devices, one or more heating devices, one or more air conditioning devices, one or more wiper devices, or a wire configured to heat the glass panel.

4. The method of claim 1, wherein the one or more environmental conditions comprise one or more of fog build-up on the glass panel, frost build-up on the glass panel, or an absence of fog and frost build-up on the glass panel.

5. The method of claim 1, wherein determining, based on the application of the one or more neural networks to the image data, the indication of the one or more environmental conditions associated with the glass panel comprises:
determining, based on an application of one or more convolutional neural networks to the image data, one or more image features associated with the image data; and
determining, based on an application of one or more neural networks to the one or more image features, the indication of the one or more environmental conditions associated with the glass panel.

6. The method of claim 5, wherein determining, based on the application of the one or more convolutional neural networks to the image data, the one or more image features associated with the image data comprises:
determining, based on an application of a first convolutional neural network to the image data, one or more fog features associated with the image data; and
determining, based on an application of a second convolutional neural network to the image data, one or more frost features associated with the image data.

7. The method of claim 6, wherein determining, based on the application of one or more neural networks to the one or more image features, the indication of the one or more environmental conditions associated with the glass panel comprises:
determining, based on an application of a first neural network to the one or one fog features associated with the image data, an indication of fog on the glass panel; and
determining, based on an application of a second neural network to the one or more frost features associated with the image data, an indication of frost on the glass panel.

8. The method of claim 7, wherein the first convolutional neural network and the first neural network are jointly trained based on one or more input training datasets comprising a plurality of images associated with a plurality of glass panel conditions and one or more output training datasets comprising a plurality of labeled images corresponding to a probability of fog build-up on a glass panel.

9. The method of claim 7, wherein the second convolutional neural network and the second neural network are jointly trained based on one or more input training datasets comprising a plurality of images associated with a plurality of glass panel conditions and one or more output training datasets comprising a plurality of labeled images corresponding to a probability of frost build-up on a glass panel.

10. The method of claim 1, wherein causing, based on the indication of the one or more environmental conditions and based on the environmental data, the one or more devices of the vehicle to activate comprises:
causing, based on the indication of the one or more environmental conditions and based on the environmental data and based on a selection of a control mode associated with the glass panel, the one or more devices of the vehicle to activate, wherein the control mode comprises a defrost mode or a defog mode.

11. The method of claim 1, wherein causing, based on the indication of the one or more environmental conditions and based on the environmental data, the one or more devices of the vehicle to activate comprises:
determining, based on the indication of the one or more environmental conditions and based on the environmental data, a heating power; and
causing, based on the heating power, the one or more devices of the vehicle to activate.

12. A system comprising:
one or more image capture devices configured to output image data associated with a glass panel of a vehicle;
one or more sensor devices configured to output environmental data associated with an interior of the vehicle;
an environmental system of the vehicle comprising one or more devices of the vehicle;
a computing device in communication with the one or more image capture devices, the one or more sensor devices, and the environmental system, wherein the computing device is configured to:
receive the image data associated with the glass panel and the environmental data associated with the interior of the vehicle,
determine, based on application of one or more neural networks to the image data, an indication of one or more environmental conditions associated with the glass panel, and
cause, based on the indication of the one or more environmental conditions associated with the glass panel and based on the environmental data associated with the interior of the vehicle, the one or more devices of the environmental system to activate.

13. The system of claim 12, wherein the image data comprises one or more images of one or more portions of the glass panel, and wherein the environmental data comprises data indicative of one or more of a temperature or a humidity characteristics of the interior of the vehicle.

14. The system of claim 12, wherein the glass panel comprises a wire configured to heat the glass panel, and wherein the one or more devices comprise one or more of one or more blower devices, one or more heating devices, one or more air conditioning devices, one or more wiper devices, or a wire configured to heat the glass panel.

15. The system of claim 12, wherein the computing device is configured to determine, based on the application of the one or more neural networks to the image data, the indication of the one or more environmental conditions associated with the glass panel, the computing device is further configured to:
determine, based on an application of one or more convolutional neural networks to the image data, one or more image features associated with the image data; and
determine, based on an application of one or more neural networks to the one or more image features, the indication of the one or more environmental conditions associated with the glass panel.

16. The system of claim 15, wherein the computing device is configured to determine, based on the application of the one or more convolutional neural networks to the image data, the one or more image features associated with the image data, the computing device is further configured to:
determine, based on an application of a first convolutional neural network to the image data, one or more fog features associated with the image data; and
determine, based on an application of a second convolutional neural network to the image data, one or more frost features associated with the image data.

17. The system of claim 16, wherein the computing device is configured to determine, based on the application of one or more neural networks to the one or more image features, the indication of the one or more environmental conditions associated with the glass panel, the computing device is further configured to:
determine, based on an application of a first neural network to the one or one fog features associated with the image data, an indication of fog on the glass panel; and
determine, based on an application of a second neural network to the one or more frost features associated with the image data, an indication of frost on the glass panel.

18. The system of claim 17, wherein the first convolutional neural network and the first neural network are jointly trained based on one or more input training datasets comprising a plurality of images associated with a plurality of glass panel conditions and one or more output training datasets comprising a plurality of labeled images corresponding to a probability of fog build-up on a glass panel, and wherein the second convolutional neural network and the second neural network are jointly trained based on one or more input training datasets comprising a plurality of images associated with a plurality of glass panel conditions and one or more output training datasets comprising a plurality of labeled images corresponding to a probability of frost build-up on a glass panel.

19. The system of claim 11, wherein the computing device is configured to cause, based on the indication of the one or more environmental conditions and based on the environmental data, the one or more devices of the vehicle to activate, the computing device is further configured to:
cause, based on the indication of the one or more environmental conditions and based on the environmental data and based on a selection of a control mode associated with the glass panel, the one or more devices of the vehicle to activate, wherein the control mode comprises a defrost mode or a defog mode.

20. The system of claim 11, wherein the computing device is configured to cause, based on the indication of the one or more environmental conditions and based on the environmental data, the one or more devices of the vehicle to activate, the computing device is further configured to:
determine, based on the indication of the one or more environmental conditions and based on the environmental data, a heating power; and
cause, based on the heating power, the one or more devices of the vehicle to activate.
